(19) United States
(12) Patent Application Publication
(10) Pub. No.: US 2026/0251148 A1
(43) Pub. Date: Aug. 27, 2026

(54) FAN PEDESTAL AND FAN

(71) Applicant: GUANGDONG MIDEA ENVIRONMENT APPLIANCES MFG CO., LTD., Zhongshan (CN)

(72) Inventor: Guopeng HE, Zhongshan (CN)

(21) Appl. No.: 19/159,202

(22) PCT Filed: Jun. 27, 2023
(86) PCT No.: PCT/CN2023/102817

§ 371 Date: Aug. 22, 2025

(30) Foreign Application Priority Data
Feb. 27, 2023 (CN) 202320349907.3

(51) Int. Cl. F04D 25/10; F04D 25/06; F04D 25/08; F04D 29/64

(52) U.S. Cl. CPC F04D 25/105; F04D 25/06; F04D 25/08; F04D 29/646

(57) ABSTRACT

A fan pedestal (10) and a fan (100). The fan pedestal includes a base (11), a first electric motor (13), and a fan seat (14). The base (11) is provided with a mounting support (12). The first electric motor (13) is provided at the mounting support (12). The fan seat (14) is rotatably provided at the mounting support (12). The fan seat (14) is in a driven connection with the first electric motor (13) to be swingable relative to the mounting support (12) under the drive of the first electric motor (13). This fan pedestal structure can prevent a wire harness from being scratched and pulled, thereby improving use safety and reliability of the fan.

### CROSS-REFERENCE TO RELATED APPLICATION

This application claims priority to Chinese patent application No. 202320349907.3, filed by Guangdong Midea Environment Appliances Manufacturing Co., Ltd. on Feb. 27, 2023, titled “FAN PEDESTAL AND FAN.”

### FIELD

The present disclosure relates to the field of home appliance technologies, and more particularly, to a fan pedestal and a fan.

### BACKGROUND

In the related art, a fan head is provided at a fan pedestal and is capable of oscillating relative to the fan pedestal vertically or horizontally.

However, in the related art in which the fan head is capable of oscillating relative to the fan pedestal vertically, there may be a relative movement between an electric motor configured to drive the fan head to oscillate vertically and the fan pedestal. During the oscillation of the fan head, a wire harness (a signal wire harness and a power supply wire harness) of the electric motor for driving the fan head to oscillate vertically is prone to being scratched, pulled, or even torn off. Thus, there is a hidden danger in use.

### SUMMARY

The present disclosure aims to solve at least one of the technical problems in the related art. Therefore, embodiments of the present disclosure provide a fan pedestal, in which a mounting support of the fan pedestal remains stationary with respect to a first electric motor, avoiding scratching and pulling of a wire harness, and thus improving use safety and reliability of the fan.

Embodiments of the present disclosure further provide a fan using the fan pedestal as described above.

The fan pedestal according to embodiments of the present disclosure includes: a base provided with a mounting support; a first electric motor provided at the mounting support; and a fan seat rotatably provided at the mounting support. The fan seat is in a driven connection with the first electric motor to be swingable relative to the mounting support under the drive of the first electric motor.

Therefore, by fixing the first electric motor at the mounting support and driving the fan seat to move relative to the base by the first electric motor, when a fan head swings relative to the fan pedestal, the first electric motor remains stationary with respect to the base. As a result, a power supply wire harness and a signal wire harness of the first electric motor can be prevented from being exposed or broken. Therefore, the use safety and operation reliability of the fan can be improved, and thus a service life of the fan can be effectively prolonged.

According to some embodiments of the present disclosure, the mounting support includes a support arm and a cross arm. An end of the support arm is connected to the base, and the cross arm is provided at the other end of the support arm. The first electric motor and the fan seat are provided at two ends of the cross arm, respectively.

In some embodiments, a rotation center of the first electric motor and a pivot center of each of the fan seat and the cross arm are located in a same horizontal plane.

According to some embodiments of the present disclosure, the fan seat is in a driven connection with the first electric motor via a transmission assembly.

In some embodiments, the transmission assembly includes: a first cam connected to a shaft of the first electric motor at a center pivot point of the first cam; a second cam connected to a rotation shaft of the fan seat at a center pivot point of the second cam; and a first connection rod. An end of the first connection rod is hinged to the first cam at an eccentric pivot point of the first cam, and the other end of the first connection rod is hinged to the second cam at an eccentric pivot point of the second cam.

In some embodiments, the cross arm has a first avoidance hole, and the motor shaft passes through the first avoidance hole to be connected to the first cam.

In some embodiments, the cross arm further has a second avoidance hole in communication with the first avoidance hole, and the second avoidance hole is configured to avoid the first cam.

In some embodiments, the fan seat has a rotation arm located at a peripheral side of a rotation shaft of the fan seat. The transmission assembly includes a third cam and a second connection rod. The third cam is connected to a motor shaft of the first electric motor at a center pivot point of the third cam. An end of the second connection rod is hinged to the third cam at an eccentric pivot point of the third cam, and the other end of the second connection rod is hinged to the rotation arm.

In some embodiments, the cross arm has a mounting hole, and the rotation shaft of the fan seat passes through the mounting hole.

In some embodiments, an anti-wear washer is provided between the rotation shaft and the cross arm.

In some embodiments, the mounting support is provided with a wire-passing structure, and a wire harness of the first electric motor extends to the base through the wire-passing structure and is connected to a power supply control at the base.

The fan according to embodiments of the present disclosure includes the fan pedestal according to any one of the above embodiments and a fan head. The fan head includes a fan blade and a second electric motor configured to drive the fan blade. The second electric motor is mounted at the fan seat of the fan pedestal.

Additional aspects and advantages of the present disclosure will be provided at least in part in the following description, or will become apparent at least in part from the following description, or can be learned from practicing of the present disclosure.

### BRIEF DESCRIPTION OF THE DRAWINGS

The above and/or additional aspects and advantages of the present disclosure will become more apparent and more understandable from the following description of embodiments taken in conjunction with the accompanying drawings.

FIG. 1 is an embodiment of a fan according to a first embodiment of the present disclosure.

FIG. 2 is a schematic view of a fan head in one position according to a first embodiment of the present disclosure.

FIG. 3 is a schematic view of a fan head in another position according to a first embodiment of the present disclosure.

FIG. 4 is a schematic exploded view of a fan pedestal according to a first embodiment of the present disclosure.

FIG. 5 is an embodiment of a fan according to a second embodiment of the present disclosure.

FIG. 6 is a schematic view of a fan head in one position according to a second embodiment of the present disclosure.

FIG. 7 is a schematic view of a fan head in another position according to a second embodiment of the present disclosure.

FIG. 8 is a schematic exploded view of a fan pedestal according to a second embodiment of the present disclosure.

### DETAILED DESCRIPTION OF THE EMBODIMENTS

Embodiments of the present disclosure will be described in detail below with reference to examples thereof as illustrated in the accompanying drawings, throughout which same or similar elements, or elements having same or similar functions, are denoted by same or similar reference numerals. The embodiments described below with reference to the drawings are illustrative only, and are intended to explain, rather than limiting, the embodiments of the present disclosure.

In the description of the present disclosure, it should be understood that, the orientation or the position indicated by terms such as “center,” “over,” “below,” “front,” “rear,”“left,” “right,” “vertical,” “horizontal,” “top,” “bottom,” “inner,” and “outer,” should be construed to refer to the orientation or the position as shown in the drawings, and is only for the convenience of describing the present disclosure and simplifying the description, rather than indicating or implying that the pointed device or element must have a specific orientation, or be constructed and operated in a specific orientation, and therefore cannot be understood as a limitation of the present disclosure.

It should be noted that the terms “first” and “second” are only used for descriptive purposes, and cannot be understood as indicating or implying relative importance or implicitly indicating the number of indicated technical features. Therefore, the features associated with “first” and “second” may explicitly or implicitly include one or more of the features. In the description of the present disclosure, unless otherwise specified, “plurality” means two or more.

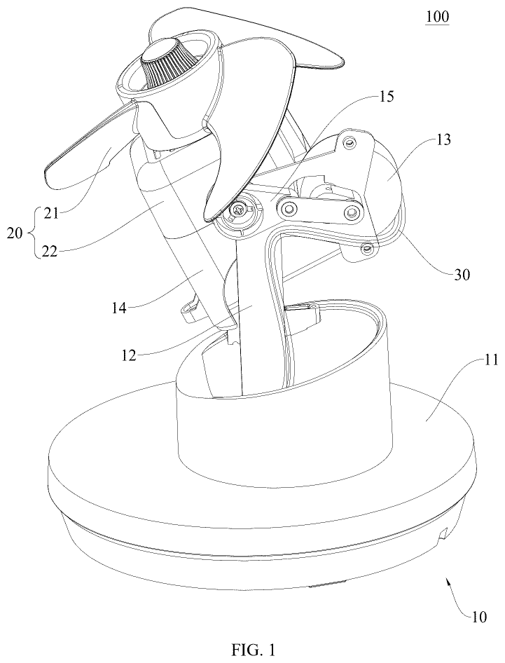

A fan pedestal 10 and a fan 100 according to embodiments of the present disclosure will be described below with reference to FIG. 1 to FIG. 8.

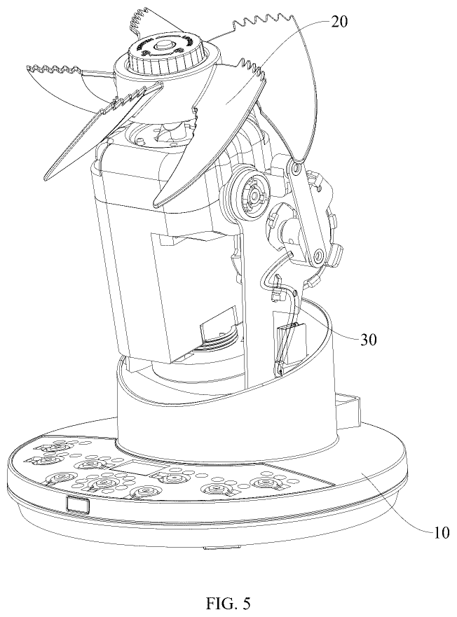

As illustrated in FIG. 1 and FIG. 5, the fan pedestal 10 according to an embodiment in a first aspect of the present disclosure includes a base 11, a first electric motor 13, and a fan seat 14.

The base 11 is provided with a mounting support 12. The first electric motor 13 is provided at the mounting support 12. The fan seat 14 is rotatably provided at the mounting support 12. The fan seat 14 is in a driven connection with the first electric motor 13 to be swingable relative to the mounting support 12 under the drive of the first electric motor 13.

The base 11 may be constructed as a rectangular block, a cylindrical block, or a block mechanism with a lower center of gravity to ensure stability of the fan pedestal 10. The mounting support 12 may be provided at a center of the base 11. An end of the mounting support 12 is connected to the base 11, and the other end of the mounting support 12 extends away from the base 11. The mounting support 12 is configured for mounting of the fan seat 14 to ensure that a fan head 20 provided at the fan seat 14 will not interfere with the base 11 during its swinging. The mounting support 12 may be constructed as a sheet metal part or a plastic part with predetermined structural strength.

The fan seat 14 is rotatable relative to the mounting support 12, and the first electric motor 13 is provided at the mounting support 12. The fan seat 14 is rotatable relative to the mounting support 12 under the drive of the first electric motor 13, and the fan head 20 mounted at the fan seat 14 is swingable under the drive of the fan seat 14. In this way, vertical or horizontal oscillation of the fan 100 is realized.

It should be noted that the first electric motor 13 may be a stepper motor or a synchronous motor. Power supply and signal interaction of the first electric motor 13 are realized through a wire harness 30. The first electric motor 13 is provided at the mounting support 12. Further, the first electric motor 13 is configured to drive the fan seat 14 to move via a transmission assembly 15 or directly drive the fan seat 14 to move, realizing swinging (i.e. oscillation) of the fan head 20 relative to the base 11. During the movement of the fan head 20 relative to the base 11, the first electric motor 13 remains stationary relative to the mounting support 12. As a result, the wire harness 30 for the supply power and signal interaction of the first electric motor 13 would not be scratched or pulled. Therefore, exposure or breakage of the wire harness 30 can be avoided.

In the fan pedestal 10 according to the embodiment of the present disclosure, by fixing the first electric motor 13 at the mounting support 12 and driving the fan seat 14 to move relative to the base 11 by the first electric motor 13, when the fan head 20 swings relative to the fan pedestal 10, the first electric motor 13 remains stationary with respect to the base 11. As a result, the power supply wire harness 30 and the signal wire harness 30 of the first electric motor 13 can be prevented from being exposed or broken. In this way, use safety and operation reliability of the fan 100 can be improved, and thus a service life of the fan 100 can be effectively prolonged.

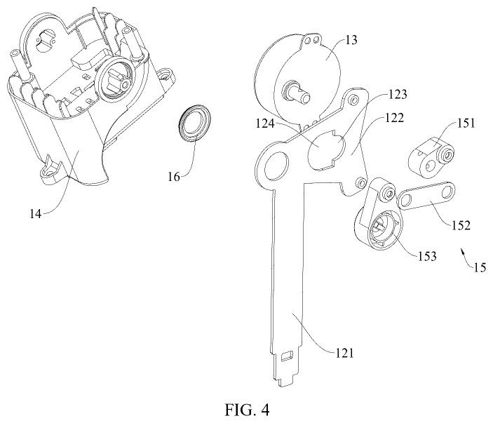

As illustrated in FIG. 4, according to some embodiments of the present disclosure, the mounting support 12 includes a support arm 121 and a cross arm 122. An end of the support arm 121 is connected to the base 11, and the cross arm 122 is provided at the other end of the support arm 121. The first electric motor 13 and the fan seat 14 are provided at two ends of the cross arm 122, respectively.

The mounting support 12 is constructed as a T-shaped arm. A bottom end of the support arm 121 is connected to the base 11, and a top end of the support arm 121 is connected to the cross arm 122. An end of the cross arm 122 is used to fix the first electric motor 13, and the other end of the cross arm 122 is pivotally engaged with the fan seat 14. A cross-sectional area of the end of the cross arm 122 for fixing the first electric motor 13 may be greater than a cross-sectional area of the other end of the cross arm 122 for fixing the fan seat 14. For example, the cross arm 122 may be of a Y shape to enable the first electric motor 13 to be fixed to the cross arm 122 at least at two positions. Therefore, fixing stability of the first electric motor 13 on the mounting support 12 can be improved.

In this way, on the one hand, the fan seat 14 and the first electric motor 13 are arranged at two ends of the cross arm 122, which can improve fixing stability of the mounting support 12 on the base 11. On the other hand, the cross arm 122 of the Y shape can improve the fixing stability of the first electric motor 13 on the mounting support 12. Therefore, structural stability and reliability of the entire fan pedestal 10 is improved.

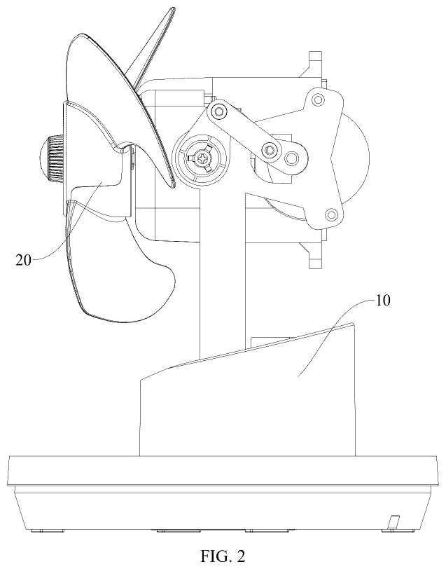

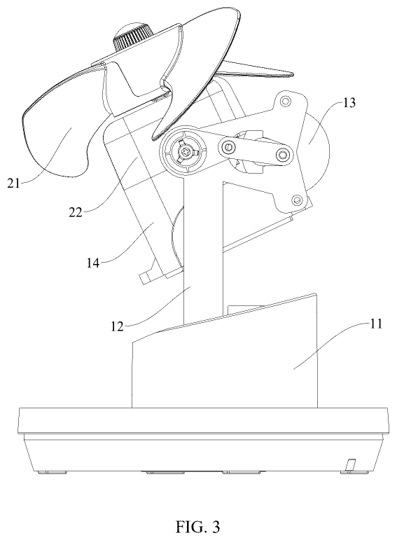

As illustrated in FIG. 2 and FIG. 3, in some embodiments, a rotation center of the first electric motor 13 and a pivot center of each of the fan seat 14 and the cross arm 122 are located in a same horizontal plane.

The fan seat 14 is rotatably provided at the cross arm 122. The pivot center of the fan seat 14 is located at the cross arm 122. The first electric motor 13 is provided at the cross arm 122, and accordingly the rotation center of the first electric motor 13 is also located at the cross arm 122. Therefore, the pivot center and the rotation center are located at the same plane. When the rotation of the first electric motor 13 drives the fan seat 14 to swing, a swing center and the rotation center are located at the same plane. In this way, the movement of the fan seat 14 can be prevented from generating a torque that would cause the base 11 and the mounting support 12 to swing. Therefore, stability and reliability of the fan pedestal 10 is improved, and vibration during operation of the fan 100 is reduced, and thus enhancing user experience.

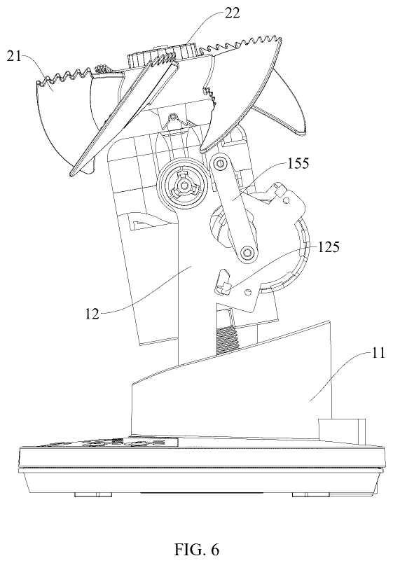

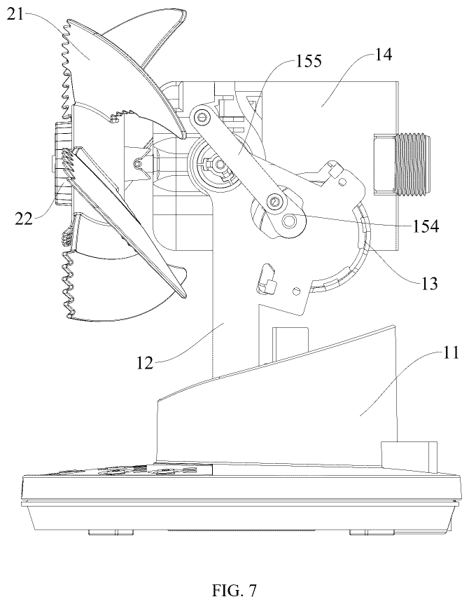

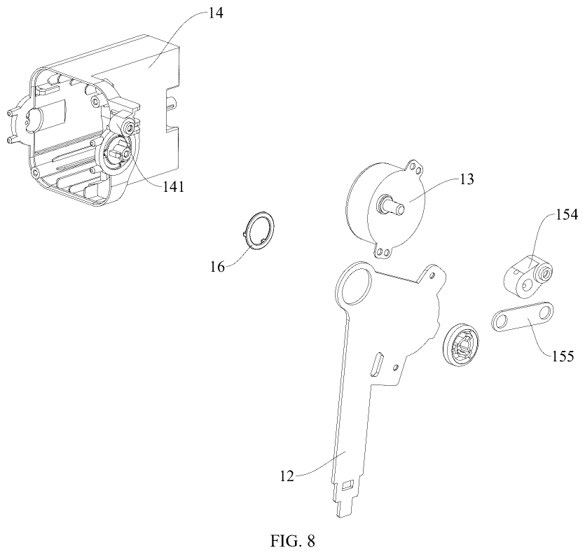

As illustrated in FIG. 2, FIG. 3, FIG. 4, FIG. 6, FIG. 7, and FIG. 8, according to some embodiments of the present disclosure, the fan seat 14 is in a driven connection with the first electric motor 13 via a transmission assembly 15.

A driving member of the transmission assembly 15 is connected to the first electric motor 13, and a driven member of the transmission assembly 15 is connected to the fan seat 14. The driving member is in a drive connection with (e.g., engaged with) the driven member directly or through an intermediate component (e.g., through a first connection rod 152, a pulley, etc.). Therefore, the transmission assembly 15 can achieve speed reduction and torque increase, improving driving stability. Therefore, the rotation of the fan seat 14 is smoother and more reliable, thereby prolonging a response time. In this way, the fan seat 14 can be effectively prevented from swinging too quickly due to an excessively high rotation speed of the first electric motor 13. Therefore, the user experience of the fan 100 is effectively enhanced.

The transmission assembly 15 may be constructed as a gear transmission pair of one or more sets of meshing gears, a belt transmission pair or a chain transmission pair of a driving gear, a driven gear, a belt or a chain to realize reciprocating swinging of the fan seat 14 between two positions (as illustrated in FIG. 2 and FIG. 3) through forward rotation and reverse rotation of the first electric motor 13. In other embodiments, the transmission assembly 15 may also be constructed as a multi-link transmission pair, a cam-link transmission pair, or the like to realize the reciprocating swinging of the fan seat 14 between two positions (as illustrated in FIG. 2 and FIG. 3) through the forward rotation and reverse rotation of the first electric motor 13.

As illustrated in FIG. 2, FIG. 3, and FIG. 4, in a first embodiment of the present disclosure, the transmission assembly 15 includes a first cam 151, a first connection rod 152, and a second cam 153. The first cam 151 is connected to a motor shaft at a center pivot point of the first cam 151. The second cam 153 is connected to a rotation shaft of the fan seat 14 at a center pivot point of the second cam 153. An end of the first connection rod 152 is hinged to the first cam 151 at an eccentric pivot point of the first cam 151, and the other end of the first connection rod 152 is hinged to the second cam 153 at an eccentric pivot point of the second cam 153.

The two cams are connected to each other by the first connection rod 152. The first cam 151 is used as the driving member, and the center pivot point of the first cam 151 rotates under the drive of the first electric motor 13, and the eccentric pivot point of the first cam 151 rotates relative to the center pivot point thereof and drives the first connection rod 152 to move towards or away from the fan seat 14. The second cam 153 is used as the driven member, and the first connection rod 152 pushes the eccentric pivot point of the second cam 153 and drives the center pivot point of the second cam 153 to rotate, and thus the second cam 153 drives the fan seat 14 to rotate.

In this way, with such an arrangement of the first cam 151, the second cam 153, and the first connection rod 152, the reciprocating swinging of the fan seat 14 between the two positions in FIG. 2 and FIG. 3 can be realized by the first electric motor 13 without changing a rotation direction of the first electric motor 13. As a result, frequent switching between the forward rotation and the reverse rotation of the first electric motor 13 can be avoided, thereby prolonging a service life of the first electric motor 13 and effectively improving operation stability of the fan 100.

In some embodiments, the cross arm 122 has a first avoidance hole 123, and the motor shaft passes through the first avoidance hole 123 to be connected to the first cam 151. The cross arm 122 further has a second avoidance hole 124 in communication with the first avoidance hole 123. The second avoidance hole 124 is configured to avoid the first cam 151.

In this way, the motor shaft is avoided by the first avoidance hole 123, and a region where the eccentric pivot point of the first cam 151 is hinged to the first connection rod 152 is avoided by the second avoidance hole 124. As a result, interference between the first cam 151 and the cross arm 122 is avoided when the first cam 151 rotates. Therefore, movement smoothness of the fan seat 14 can be effectively improved, and noise during transmission of the transmission assembly 15 can be reduced.

A structure of the transmission assembly 15 of the embodiment of the present disclosure is not limited thereto. In a second embodiment, the transmission assembly 15 includes a third cam 154 and a second connection rod 155. The fan seat 14 has a rotation arm 141 located at a peripheral side of a rotation shaft of the fan seat 14. The third cam 154 is connected to the motor shaft at a center pivot point of the third cam 154. Further, the third cam 154 is hinged to an end of the second connection rod 155 at an eccentric pivot point of the third cam 154. The other end of the second connection rod 155 is hinged to the rotation arm 141.

In the second embodiment, the transmission assembly 15 is still constructed as a cam-link transmission pair, and the second connection rod 155 directly drives the rotation arm 141 eccentrically provided at the peripheral side of the rotation shaft to drive the fan seat 14 to rotate, which can provide the same technical effect as the first embodiment, and thus details thereof will be omitted herein.

As illustrated in FIG. 4, the cross arm 122 has a mounting hole, and the rotation shaft of the fan seat 14 passes through the mounting hole.

The mounting hole is constructed as a circular hole or an oblong hole. The rotation shaft of the fan seat 14 and the second cam 153 may be connected to each other by a spline or be rotatably provided at the mounting support 12 directly, and the rotation shaft passes through the mounting hole. In this way, the cross arm 122 can be prevented from interfering with rotation of the fan seat 14 while the fan seat 14 is fixed at the mounting support 12. Therefore, the movement smoothness and reliability of the fan seat 14 is improved.

An anti-wear washer 16 is provided between the rotation shaft and a second support 12. Therefore, by the anti-wear washer 16, rotational wear between the rotation shaft and the second cam 153 or the second support 12 can be reduced. Therefore, the service life is prolonged, and the fan seat 14 can be prevented from moving while rotating, thereby improving rotational smoothness.

In other embodiments of the present disclosure, the rotation of the fan seat 14 relative to the cross arm 122 may be realized by disposing a bearing in the mounting hole and fixing the rotation shaft to an inner ring of the bearing.

As illustrated in FIG. 5, the mounting support 12 is provided with a wire-passing structure 125. The wire harness 30 of the first electric motor 13 extends to the base 11 through the wire-passing structure 125, and is connected to a power supply control at the base 11.

Therefore, the wire harness 30 may be fixed by the wire-passing structure 125, improving fixing stability of the wire harness 30, and ensuring that the wire harness 30 would not be disengaged from the wire-passing structure 125 due to its own deflection. Further, the wire harness 30 can be prevented from being scratched or pulled, thereby improving use safety and reliability.

As illustrated in FIG. 1, a fan 100 according to an embodiment in a second aspect of the present disclosure is provided. The fan 100 includes the fan pedestal 10 according to any one of the above embodiments, and a fan head 20. The fan head 20 includes a fan blade 21 and a second electric motor 22 configured to drive the fan blade 21. The second electric motor 22 is mounted at the fan seat 14 of the fan pedestal 10.

The fan 100 according to the embodiment of the present disclosure incorporates the fan pedestal 10 as described above. Therefore, the same technical effect as that of the fan pedestal 10 can be provided, and thus details thereof will be omitted herein.

In addition, the terms such as “first” and “second” are only used for descriptive purposes, and cannot be understood as indicating or implying relative importance or implicitly indicating the number of indicated technical features. Therefore, the features associated with “first” and “second” may explicitly or implicitly include one or more of the features. In the description of the present disclosure, “plurality” means two or more, unless otherwise specifically defined.

In the present disclosure, unless otherwise clearly specified and limited, terms, such as “mounting,” “connect,” “connect to,” “fixed to,” or the like, should be understood in a broad sense. For example, it may be a fixed connection or a detachable connection or connection as one piece; mechanical connection or electrical connection, or communication connection; direct connection or indirect connection through an intermediate; internal communication of two components or the interaction relationship between two components. For those skilled in the art, specific meanings of the above-mentioned terms in the present disclosure can be understood according to specific circumstances.

In the present disclosure, unless otherwise clearly specified and limited, the first feature “on” or “under” the second feature may mean that the first feature is in direct contact with the second feature, or the first and second features are in indirect contact through an intermediate. In addition, the first feature “above” the second feature means that the first feature is directly above or obliquely above the second feature, or simply means that the level of the first feature is higher than that of the second feature. The first feature “below” the second feature may mean that the first feature is directly below or obliquely below the second feature, or simply mean that the level of the first feature is smaller than that of the second feature.

In the present disclosure, the description with reference to the terms “one embodiment,” “some embodiments,” “an example,” “a specific example,” or “some examples,” etc., means that specific features, structures, materials, or characteristics described in conjunction with the embodiment(s) or example(s) are included in at least one embodiment or example of the present disclosure. In the present disclosure, any illustrative reference of the above terms does not necessarily refer to the same embodiment(s) or example(s). Further, the particular features, structures, materials, or characteristics may be combined in any suitable manner in any one or more embodiments or examples. In addition, different embodiments or examples and features of different embodiments or examples described in the specification may be combined by those skilled in the art without mutual contradiction.

Although embodiments of the present disclosure have been illustrated and described, it is conceivable for those of ordinary skill in the art that various changes, modifications, replacements, and variations can be made to these embodiments without departing from the principles and spirit of the present disclosure. The scope of the present disclosure shall be defined by the claims as appended and their equivalents.

1.-12. (canceled)

13. A fan pedestal comprising:
a base provided with a mounting support;
an electric motor provided at the mounting support; and
a fan seat rotatably provided at the mounting support and connected to the electric motor, and configured to be driven by the electric motor to swing relative to the mounting support.

14. The fan pedestal according to claim 13, wherein the mounting support includes:
a support arm, an end of the support arm being connected to the base; and
a cross arm provided at another end of the support arm, the electric motor and the fan seat being provided at two ends of the cross arm, respectively.

15. The fan pedestal according to claim 14, wherein a rotation center of the electric motor and pivot centers of the fan seat and the cross arm are located in a same horizontal plane.

16. The fan pedestal according to claim 14, wherein the fan seat is connected to the electric motor via a transmission assembly.

17. The fan pedestal according to claim 16, wherein the transmission assembly includes:
a first cam connected to a motor shaft of the electric motor at a center pivot point of the first cam;
a second cam connected to a rotation shaft of the fan seat at a center pivot point of the second cam; and
a connection rod, an end of the connection rod being hinged to the first cam at an eccentric pivot point of the first cam, and another end of the connection rod being hinged to the second cam at an eccentric pivot point of the second cam.

18. The fan pedestal according to claim 17, wherein the cross arm has a first avoidance hole, the motor shaft passing through the first avoidance hole to be connected to the first cam.

19. The fan pedestal according to claim 18, wherein:
the cross arm further has a second avoidance hole in communication with the first avoidance hole, the second avoidance hole being configured to avoid the first cam.

20. The fan pedestal according to claim 16, wherein:
the fan seat includes a rotation arm located at a peripheral side of a rotation shaft of the fan seat; and
the transmission assembly includes:
a cam connected to a motor shaft of the electric motor at a center pivot point of the cam; and
a connection rod, an end of the connection rod being hinged to the cam at an eccentric pivot point of the cam, and another end of the connection rod being hinged to the rotation arm.

21. The fan pedestal according to claim 14, wherein the cross arm has a mounting hole, a rotation shaft of the fan seat passing through the mounting hole.

22. The fan pedestal according to claim 21, wherein an anti-wear washer is provided between the rotation shaft and the cross arm.

23. The fan pedestal according to claim 13, wherein the mounting support is provided with a wire-passing structure, a wire harness of the electric motor extending to the base through the wire-passing structure and being connected to a power supply control at the base.

24. A fan comprising:
a fan pedestal including:
a base provided with a mounting support;
a first electric motor provided at the mounting support; and
a fan seat rotatably provided at the mounting support and connected to the first electric motor, and configured to be driven by the first electric motor to swing relative to the mounting support; and
a fan head including:
a fan blade; and
a second electric motor mounted at the fan seat and configured to drive the fan blade.

25. The fan according to claim 24, wherein the mounting support includes:
a support arm, an end of the support arm being connected to the base; and
a cross arm provided at another end of the support arm, the first electric motor and the fan seat being provided at two ends of the cross arm, respectively.

26. The fan according to claim 25, wherein a rotation center of the first electric motor and pivot centers of the fan seat and the cross arm are located in a same horizontal plane.

27. The fan according to claim 25, wherein the fan seat is connected to the first electric motor via a transmission assembly.

28. The fan according to claim 27, wherein the transmission assembly includes:
a first cam connected to a motor shaft of the first electric motor at a center pivot point of the first cam;
a second cam connected to a rotation shaft of the fan seat at a center pivot point of the second cam; and
a connection rod, an end of the connection rod being hinged to the first cam at an eccentric pivot point of the first cam, and another end of the connection rod being hinged to the second cam at an eccentric pivot point of the second cam.

29. The fan according to claim 28, wherein the cross arm has a first avoidance hole, the motor shaft passing through the first avoidance hole to be connected to the first cam.

30. The fan according to claim 29, wherein:
the cross arm further has a second avoidance hole in communication with the first avoidance hole, the second avoidance hole being configured to avoid the first cam.

31. The fan according to claim 27, wherein:
the fan seat includes a rotation arm located at a peripheral side of a rotation shaft of the fan seat; and
the transmission assembly includes:
a cam connected to a motor shaft of the first electric motor at a center pivot point of the cam; and
a connection rod, an end of the connection rod being hinged to the cam at an eccentric pivot point of the cam, and another end of the connection rod being hinged to the rotation arm.

32. The fan according to claim 25, wherein the cross arm has a mounting hole, a rotation shaft of the fan seat passing through the mounting hole.
